(19) United States
(12) Patent Application Publication
(10) Pub. No.: US 2002/0140306 A1
(43) Pub. Date: Oct. 3, 2002

(54) Open end spin-rotor with an attachable support cap

(75) Inventors: Edmund Schuller, Ingolstadt (DE); Manfred Knabel, Ingolstadt (DE); Werner Strasser, Steckborn (CH)

Correspondence Address: STEPHEN E. BONDURA, ESQ., DORITY & MANNING, P.A., P.O. BOX 1449, GREENVILLE, SC, 29602-1449, US

(73) Assignee: RIETER INGOLSTADT SPINNEREIMASCHINENBAU AG

(21) Appl. No.: 10/074,579

(22) Filed: Feb. 13, 2002

(30) Foreign Application Priority Data
Feb. 14, 2001 (DE) 101 06 726.7

(51) Int. Cl. H02K 5/00

(52) U.S. Cl. 310/91

(57) ABSTRACT

The invention concerns an open-end spin-rotor with a shaft (1), on the free end of which a support cap (7d) can be attached, a support cap for this service as well as a procedure for the manufacture of an open-end spin rotor. In accord with the invention, the open-end spin-rotor is improved in such a manner, that the shaft (1) possesses an alignment surface (5, 6) on the end face and the support cap (7d) exhibits a counter alignment surface (9, 10) for the alignment of said support cap (7d) relative to a plane disposed perpendicular to the rotor axis and/or an inclined alignment surface for the alignment and coaxial centering of the support cap on the shaft (1).

### DESCRIPTION

The invention concerns an open end spin rotor with a shaft, upon the free end of which a support cap can be attached, and concerns also the support cap for the said purpose.

In the case of a rotor shaft disclosed by DE 40 20 411 A1, on the free end of the rotor shaft, a support cap is placed on an attachment or a fitting. Upon the operation of the spin-rotor, the free end of the shaft is pressed against a ball, which is driven by the rotation of the support cap, so that the said ball entrains lubrication from a lubrication reservoir between the ball surface and the surface of the support cap. The outer surface of a pin serves as a guide surface for the centering and alignment of the support cap, whereby the penetrative depth of the pin into the support cap runs over half of the entire depth of the support cap. Simultaneously, the outer, circumferential surface of the pin and the inner surface of the support cap are united by force-fit, so that the support cap must be pressed onto the free end of the shaft of the rotor. Because of the force-fit, the air volume in the support cap is compressed by the insertion of the pin. In order to be able to insert the said pin up to the optional depth of penetration, the boring in the support cap is deeper than the height of the pin, so that a dead-space for the reception of the compressed air is created. Since the bearing surface of the support cap suffers wear through the bearing on the ball, the support cap is exchangeable, which is allowed by the said force-fit,. In this way, the support cap is freed from the shaft of the rotor and replaced by a new cap, as soon as the wear has progressed to an unacceptable point. By the employment of a ceramic material for the support cap, the danger exists, because of the friable nature of the material, that because of the radial stress of force-fitting, the shell of the support cap, upon being so pressed, will fracture. Also, because of temperature gradients between the support cap and the pin, as well as on the basis of different heat expansion coefficients, due to operational heating of the shaft of the rotor, that is, also the support cap, fissures can develop in the shell and the disintegration of the support cap can occur. Further, it is also possible that, because of vibrations from the spin-rotor, such vibrations being caused, for instance, by impacts between the support cap and the bearing ball, the force-fit will loosen, and with the help of the heated and compressed air in the dead space, the support cap can burst. Finally, the radial stress of the force-fit requires a thick wall structure, so that the diameter of the cap becomes large. On the basis of this large diameter of the support cap, the means of lubrication, which is entrained by the ball from the lubricant supply onto the support cap, is flung from the support cap by the described large diameter with a high centrifugal force and thus with a high velocity, so that the lubricant is disseminated over a very wide area about the axial bearing. As has already been mentioned above, in the case of this support cap, the alignment of the support cap to the shaft of the spin-rotor is carried out through axially running guide or alignment surfaces, which only lead to an effective alignment, when at the same time a radially acting force-fit has been effected, which is associated with the above described problems.

Thus, it is the purpose of the invention to provide an open-end spin-rotor with an attachable support cap, as well as such a support cap and a procedure for the manufacture of the same, in which a simple and secure alignment of the support cap is attained, which is to say, of the open-end spin-rotor, without the risk of consequential damages.

This purpose is achieved by the features of the claims 1, 3, 17, 19 or 20.

In the case of an open end spin-rotor with the features in accord with the concept of claim 1, there is provided on the face of the free end of the shaft an alignment surface, to which the support cap provides a confronting end-face alignment surface to align the support surface of the support cap to the rotor axis. By this means, two surfaces are set, parallel to one another, which, first, is a surface perpendicular to the axis of the shaft, and second, a surface perpendicular to the axis of the support cap. By means of the parallel alignment of the planes, the two axes are at least made parallel to one another. With this situation, assurance is given, that in the case of a flat support surface, the separation between the bearing ball and the shaft remains the same, without the support cap. On this account, axial vibrations of the shaft, because of an axial misadjustment, are avoided.

An alignment surface, is, relative to the above, normally a surface, against which a corresponding counter aligned surface is positioned, so that these surfaces are caused to lie parallel to one another. In doing this, the alignment surface and the counter alignment surface are in direct contact, or, for example, the alignment surfaces are brought into parallel positioning with an interposed layer. This separating interposed layer can be, for example, an adherent coating means, which is apportioned to each surface in a layer of uniform thickness.

Since, in the case of a bearing which is off-center, which is installed intentionally, or is employed because of alignment deviations, the ball of the axial bearing, located on the support surface of the support cap, is not centered on the axis, but rather offset therefrom, accordingly runs on a circular line on the surface of the support cap. If, after the fastening of the support cap on the rotor shaft, the axis of the support cap stands at an angle to the rotor axis, then, during the rotation, the distance between the ball and the rotor shaft changes. Because of the high rate of rotation and the axial thrust on the rotor in the direction of the ball, there occurs a lifting and dropping of the support surface similar to percussion drilling of the support cap against the ball surface. To avoid this imbalance, it is therefore a requirement, that the rotational axis of the support cap and the rotational axis of the shaft are aligned to be parallel to one another. Opposing this imbalance, is an insignificant radial imbalance, which is activated by radial misadjustment of the support cap on the shaft. Since the diameter of the support cap is small, thus this radial imbalance moment is small, relative to the entire spin-rotor.

Further, it is not necessary, to provide an axially running alignment surface, which requires an axially active force-fit. On this account, the wall thickness of the shell of the support cap can be kept thin, so that the dissemination of lubrication means is minimized and a destruction, i.e., a bursting of the support cap cannot occur.

In an advantageous embodiment, the depth of the recess in the support cap can be equal to or less than half of the entire height of the support cap. Because of the alignment at end surfaces and/or inclined alignment surfaces, it is not necessary to subject the radially extending inner surfaces of the support cap, or the outer surface of the pin to alignment. Further, the required radial support of the support cap on the end of the shaft is very small, so that the shaft need penetrate the support cap only to a very small extent. Because of the small depth of the recess in the support cap, the support cap is simpler to manufacture.

Since no radially acting force-fitting is required, between the outer surfaces of the pin of the shaft and the inner wall of the support cap, a distance for play is provided, so that the requirement for dimensional precision during manufacture is reduced. Additionally, because of the space for play between the outside surface of the pin and the inner wall of the support cap, the air expelled from the support cap by the pin can easily escape. A compression of the air or operational heat expansion of air does not occur.

Alternative to, or in addition to the alignment surface of the end face on the shaft, an inclined alignment face can be provided, which confronts a correspondingly constructed centering surface of the support cap upon the shaft end. A result of the mutually aligned inclinations of the shaft and the support cap, is likewise, a parallel arrangement of the axes of rotation of the support cap and the shaft. This allows the accomplishment of the above described alignment of the support surface of the support cap to the said ball. At the same time, the slanted, rotationally symmetrical centering surface, i.e., alignment surface (for example, conical or cone-frustum surface) brings about a coaxial alignment of the support cap to the shaft. By means of this, it is possible to minimize or eliminate a radial imbalance.

In a particularly advantageous embodiment, an end face is used as the alignment surface of the shaft. This could be effected by a pin which lies at the base of the support cap as an opposing alignment surface. In doing this, the surface for the alignment must be very large, while the wall of the support cap, which surrounds the pin, can kept very thin.

If the inclination of the alignment surface lies in the range of 45°, then by the use of an adhesive material for securing the support cap to the shaft, a particularly stable connection can be made. In this case, an axial or a radial loading of the support cap acts not only perpendicular to the adherent surface, but also in a parallel direction thereto, whereby an adhesive will be found particularly strong in resisting shear.

In this case, the use of an adhesive for the fastening of the support cap onto the shaft proves to be an especially rapid and low cost method. A release of the grip of the adhesive must not be taken as a given matter, since normally the wear of the rotor plate or the rotor shaft lies in the area of the wear of the support cap, so that the spin-rotor is preferentially replaced as a complete assembly.

If, as an adherent material, an adhesive is employed, which retains its resilient characteristics after the cure, then the adhesive acts between the support cap and the shaft as a damping element, which leads to a damping of the bearing. Vibrations of the shaft are then not directly imparted, at full impulse, onto the ball which serves for axial bearing. On this account the alignment surfaces of the support elements and the surface of the ball are less subjected to damage, so that the operational life of the axial bearing is additionally increased.

If the support surface of the support cap is flat, then it suffices to do no more than to align the alignment surfaces of the support cap and the end of the shaft with one another. A coaxial alignment is no longer necessary, since even in the case of a slight axial misadjustment of the support cap, the rotor shaft always runs in one plane along the support ball. Requirements for precision of dimensioning in the case of radial measurement and for radial adjustments upon the setting of the support cap on the shaft are, on this account, very small.

By means of provision of an air escape passage in the shaft and/or furnishing an air escape channel in the support cap, it becomes possible, upon the setting of the support cap on the shaft, to allow the air, which was compressed by a pin or a bolted end of the spin-rotor in the cap, to escape without further measures. Thereby, an air pocket in the support cap is prevented. On this account, there must be no dead space provided, within which, the air, which has infiltrated through the bolts into the support cap, can be compressed. There is no pressurized air present, which can erupt from the shaft by the vibration of the support cap. With the use of an adhesive as a fastening means, of the support cap on the shaft, superfluous adhesive can escape through the deaeration opening and/or through the air relief channel, so that only a thin layer of adhesive remains between the alignment surfaces and thus a precise alignment of the said surfaces can be accomplished.

Alternatively, between the outer surface of the pin and the inner surface of the support cap, a passage can be provided, through which the air relief is carried out, since for the fastening of the support cap, no radially acting force-fit is necessary.

In accord with claim 17, a support cap for attachment on a shaft of an open-end spin rotor is provided. The support cap has a complementary counter alignment surface for the alignment of the support cap relative to a shaft-end alignment surface and/or an inclined centralizing surface, with which the support cap can be aligned against an inclined alignment surface on the shaft. Thereby the possibility is presented, of quickly and simply aligning the support cap when it is being attached to the shaft. With this arrangement, the described features of the support cap achieve the above described advantages.

In accord with the procedure for the manufacture of an open-end rotor in accord with claim 19, before the fastening of the support cap onto the shaft, the shaft is coated with a layer of a hard substance. As a result of this, the support cap itself, and its fastening to the shaft need not undergo the working and manufacturing processes for the shaft. If, for instance, the shaft, after the coating with the coating of hard material is subjected to a tempering procedure, this has no negative effect on the fastening of the said support cap which is to be carried out as a later step.

On the other hand, in accord with the procedure taught by claim 20, the support cap can be fastened on the shaft, before the shaft itself is coated with the hard material. When this done, the precision of the dimensional accuracy achieved in the manufacture of the basic form by the fastening and alignment of the support cap on the shaft remains unchanged. Changes in dimensional accuracy by non-uniform coating of the shaft thus play no role, since these are already mounted on the shaft. If, during the coating procedure, a tempering process is also carried out, then, for example, the adhesive used would be simultaneously cured by the tempering process, so that the manufacturing time as well as the production costs are reduced.

If the support cap is fastened by means of adhesive to the shaft, then the adhesive can be applied on the bottom of the support cap and/or on the end face of the shaft. Then the fitting on the shaft is inserted into the support cap and the first, the air is completely expelled before the adhesive is pressed out by the shaft insertion. In this way, an occlusion of air between the shaft and the support cap is avoided, so that the adhering surface is uniformly covered by the adhesive and a pressure build-up of the air warmed by operation of the spin-rotor is avoided.

With the aid of drawings, embodiment examples of the invention are described in more detail below. There is shown in:

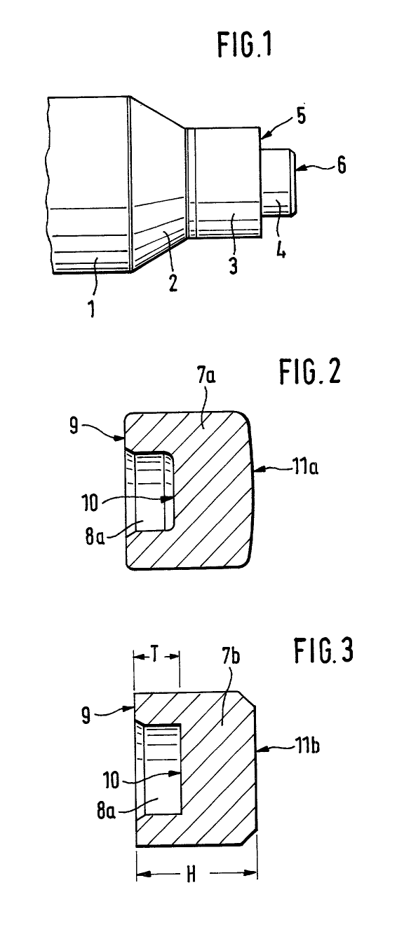

FIG. 1 the free end of a rotor shaft which is distal from a rotor plate,

FIG. 2 a first embodiment of a support cap with a crowned bearing surface,

FIG. 3 a second embodiment of a support cap with a flat bearing surface,

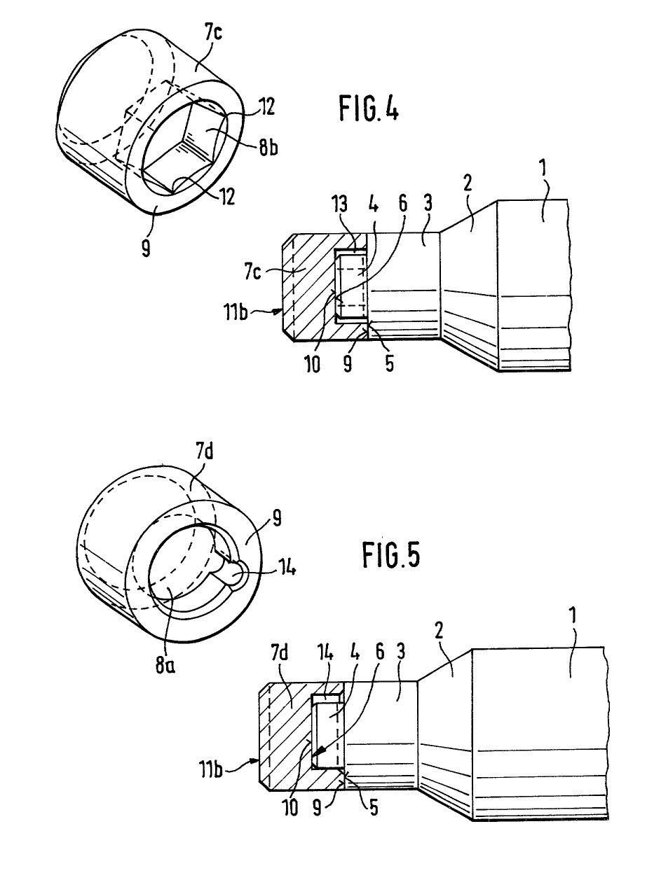

FIG. 4 a third embodiment of a support cap as well as the end of the rotor shaft with the attached support cap and

FIG. 5 a fourth embodiment of a support cap as well as the end of the rotor shaft with the attached support cap.

FIG. 1 shows the free end of the shaft 1 of a spin-rotor for an open-end spinning machine. The free end of the rotor-shaft 1 lies remote from the rotor plate of the spin-rotor and possesses a conically tapered transition section 2 for the reduction of the shaft diameter, a cylindrical section 3 thereafter and a pin shaped section 4. The cylindrical section 3 has an edging 5 on the end face, which serves as a receiving means and alignment surface for support cap 7a, b, c, d. Further, the pin shaped section 4 exhibits a flat end piece 6, which likewise serves as an alignment means or contact surface for the support cap.

A first embodiment example of a support cap 7a is presented in FIG. 2. The outside diameter of the support cap 7a corresponds to the outside diameter of the cylindrical section 3. The pin shaped section 4 of the shaft 1, permits itself to be inserted completely into the essentially cylindrical recess 8 of the support cap 7a. The back side, annular shaped end face 9 of the support cap 7a, serves as a counter surface for the contacting surface, that is, the alignment surface of the edging 5. The bottom 10 of the cylindrical recess 8 forms the counter surface for the end face 6 of the pin shaped section 4.

The alignment, parallel to the axis, of the support cap 7a in relation to the rotor shaft 1, is made in this case by the contacting, that is, the alignment of the surface 5 to the surface 9 as well as the contacting, that is, the alignment of the surface 10 to the surface 6. Alternately, the alignment of the support cap 7a can be accomplished by an alignment of the surfaces 10 and 6 to one another, or the mutual alignment of the surfaces 9 and 5.

The forward end face of the support cap 7a is formed by a crowned convex bearing surface 11a, which lies against a freely rotatable ball of the axial bearing. Such a ball is presented, for instance in FIG. 1 and a corresponding setting of the bearing of a spin-rotor in FIGS. 1 and 2 of DE 40 20 411 A1.

Insofar as not elsewhere described, the support caps 7b, 7c, and 7d and the rotor-shaft of the second, third and fourth embodiment examples represent the support cap 7a and the rotor-shaft 1 of the first embodiment example.

The same, or the same acting components are designated by the same reference numbers.

FIG. 3 shows a second embodiment of a support cap 7b, in which the end face bearing surface 11b is constructed to be flat. Independent of a probably occurring, radial misalignment of the support cap 7b relative to the shaft 1, that is to say, by two parallel, but not coaxial alignment of the axes of the closure cap and the rotor shaft 1, the separating distance between the touching point to the ball of the axial bearing and the rotor shaft 1, remains constant, and independent of the angle of rotation of the rotor-shaft.

The support caps 7a, 7b and the support caps 7c and 7d, the latter as described below, are made to adhere to the free end of the rotor shaft 1 by adhesive. For this purpose, the adhesive means is applied either on the bottom 10 of the support cap and/or on the end face 6 of the pin shaped section 4. Upon the insertion of the pin shaped section 4 into the recess 8, first, because of the present play between the inner wall of the cylindrical recess and the outer circumferential surface of the pin shaped section 4, the air is expelled out of the cylindrical recess 8. Subsequently the adhesive means is expelled through the same passages. In this way, assurance has been given, that upon pressing the support cap 7a, 7b, 7c, 7d no air remains between the surfaces 10 and 6, 5 and 9 nor between the outer circumferential surface of the pin shaped section 4 and the inner wall of the cylindrical recess 8.

Since the connection and the alignment of the support cap in FIG. 3 is exclusively, or predominately, made by means of the surfaces 6, 10, and 9, 5, it suffices, to insert the pin shaped section 4 only a small distance into the support cap 7b. As is depicted, the insert depth T shows only a third of the entire height H of the support cap 7b. In the case of (not shown) other embodiments, it suffices if T≦H/2, preferably T≦H/3.

FIG. 4 shows a third embodiment example of a support cap 7c and the free end of a rotor shaft 1 with the attached support cap 7c. A recess 8b in the support cap 7c is hexagonal, so that following the insertion of the said support cap 7c onto the pin shaped section 4, the neighboring positions of the inner surface of the recess 8b lie line shaped on the outer circumference of the pin shaped section 4. Between the outside edges 12 of the hexagonal recess 8b and the outside circumferential surface of the pin shaped section 4, there are created thus, in axial direction, continuous hollow passages 13, through which, upon the insertion of the support cap 7c, air can escape.

FIG. 5 shows a fourth embodiment example of a support cap 7d, wherein a semicircular air escape channel 14 is designed which is placed bordering a cylindrical recess 8a in the support cap 7d. By means of the air escape channel 14, likewise, upon the insertion of the support cap 7d onto the rotor shaft 1, air has an escape route.

Claimed is:

1. An open-end spin-rotor with a shaft (1), on the free end of which a support cap (7a, 7b, 7c, 7d) can be attached, wherein the support cap (7a, 7b, 7c, 7d) possesses a support surface (11a, 11b) for the axial bearing of the spin-rotor, therein characterized, in that the shaft (1) has an end face alignment surface (5, 6) and the support cap (7a, 7b, 7c, 7d) possesses a counter alignment surface (9, 10) for the alignment of the support surface (11a, 11b) relative to a plane vertically disposed to the rotor axis.

2. An open-end spin-rotor in accord with claim 1, therein characterized, in that shaft (1) on its free end additionally possesses an inclined alignment surface and the support cap (7a, 7b, 7c, 7d) has a correspondingly designed centralizing surface for the coaxial centering of the support cap (7a, 7b, 7c, 7d) to the axis of the rotor.

3. An open-end spin-rotor with a shaft (1) on the free end of which, a support cap (7a, 7b, 7c, 7d) can be attached, wherein the support cap (7a, 7b, 7c, 7d) possesses a support surface (11a, 11b) for the axial bearing of the spin-rotor, therein characterized, in that the shaft (1) on its free end has an inclined alignment surface and the support cap (7a, 7b, 7c, 7d) possesses a correspondingly designed centralizing surface, in order to center the support cap (7a, 7b, 7c, 7d) coaxially to the rotor axis and in order the align the support surface (11a, 11b) relative to a plane disposed perpendicularly to the axis of the rotor.

4. An open-end spin rotor in accord with claim 3, therein characterized, in that the shaft (1) possesses a end face alignment surface (5, 6) and the support cap (7a, 7b, 7c, 7d) has a counter alignment surface (9, 10) for the alignment of the support surface (11a, 11b) relative to a plane disposed perpendicular to the axis of the rotor.

5. An open-end spin-rotor in accord with claim 1, 2, or 4, therein characterized, in that the counter alignment surface (9, 10) of the support cap (7a, 7b, 7c, 7d) is the lower edge (9) and/or the bottom (10) of the support cap (7a, 7b, 7c, 7d).

6. An open-end spin rotor in accord with one of the claims 2 to 5, therein characterized, in that the inclined alignment surface is conical or nearly conical and/or exhibits a angle of incline of the alignment surface of about 45°.

7. An open-end spin rotor in accord with one of the foregoing claims, therein characterized, in that the support cap (7a, 7b, 7c, 7d) is made from a ceramic material or of a hard metal.

8. An open-end spin-rotor in accord with one of the foregoing claims, therein characterized, in that the support cap (7a, 7b, 7c, 7d) is adherently fastened by means of an adhesive means onto the free end of the shaft (1).

9. An open-end spin-rotor in accord with one of the foregoing claims, therein characterized, in that the support surface (11b) is flat and is placed perpendicularly to the axis of the rotor by the alignment surface.

10. An open-end spin-rotor in accord with one of the claims 1 to 9, therein characterized, in that the support surface (11b) is a crowned surface.

11. An open-end spin-rotor in accord with one of the foregoing claims, therein characterized, in that, in the shaft, at least one air escape channel is provided, which at least has one opening in the area of the surface of the outer surface of the end of the shaft covered by the support cap (7a, 7b, 7c, 7d) and possesses at least one opening to the outer side of the shaft (1) which is not covered by the support cap (7a, 7b, 7c, 7d).

12. An open-end spin-rotor in accord with claim 11, therein characterized, in that the air-escape channel is a groove in the outer surface of the shaft 1 which is at least partially covered by the support cap (7a, 7b, 7c, 7d).

13. An open-end spin-rotor in accord with one of the foregoing claims, therein characterized, in that the support cap (7a, 7b, 7c, 7d) possesses at least one air escape channel (13, 14) from the interior of the cap to the outside of the cap.

14. An open end spin-rotor in accord with claim 13, therein characterized, in that the air escape channel (13, 14) runs at least partially on the inside of the cap.

15. An open-end spin rotor in accord with claim 13 or 14, therein characterized, in that a plurality of air escape channels (13), are respectively apportioned at the same angle spacing to one another on the circumference of the support cap (7a, 7b, 7c, 7d).

16. An open-end spin-rotor in accord with claim 13, 14 or 15, therein characterized, in that at least one air escape channel is an axial boring through the bottom (10) of the support cap (7a, 7b, 7c, 7d).

17. A support cap for attachment on a shaft (1) of an open-end spin-rotor, whereby the support cap (7a, 7b, 7c, 7d) has a support surface (11a, 11b) for the axial bearing of the spin-rotor, therein characterized, in that the support cap (7a, 7b, 7c, 7d) possesses a counter alignment surface (9, 10) for the alignment of the support surface (11a, 11b) relative to an end face alignment surface (5, 6) of the shaft (1) and/or has an inclined centering surface in order to align the support cap (7a, 7b, 7c, 7d) in relation to an inclined alignment surface on the free end of the shaft (1).

18. A support cap in accord with claim 17, therein characterized, in that the support cap (7a, 7b, 7c, 7d) is constructed in accord with one of the claims 1 to 16.

19. A procedure for the manufacture of an open end spin-rotor with a support cap (7a, 7b, 7c, 7d), having the steps:
fabrication of the basic shaping of the shaft (1) with the pin-like projection (4) for the support cap (7a, 7b, 7c, 7d)
coating of the shaft (1) with a hard layer and
the fastening of the support cap (7a, 7b, 7c, 7d) on the shaft (1).

20. A procedure for the manufacture of an open end spin-rotor with a support cap (7a, 7b, 7c, 7d), having the steps:
fabrication of the basic shaping of the shaft (1) with the pin-like projection (4) for the support cap (7a, 7b, 7c, 7d)
the fastening of the support cap (7a, 7b, 7c, 7d) on the shaft (1) and
coating of the shaft (1) with a hard layer.

21. A procedure in accord with claim 19 or 20, characterized by the step:
hardening the shaft (1) after the fabrication of the basic shape of the shaft (1).

22. A procedure in accord with claims 19, 20 or 21, characterized by the step:
heat treatment of the coating during or after the application of the said coating.

23. A procedure in accord with one of the claims 19 to 22, therein characterized, in that support cap (7a, 7b, 7c, 7d) is fastened by means of an adhesive on the shaft (1).

24. A procedure in accord with claim 23, therein characterized, in that the adhesive is an adhesive which is thermally curable.

25. A procedure in accord with claim 23 or 24, therein characterized, in that prior to the attachment of the support cap (7a, 7b, 7c, 7d) onto the shaft (1), the adhesive means is applied to the bottom (10) of the a said support cap and/or on a central end face (6) of the shaft (1).

26. A procedure in accord with one of the claims 19 to 25, characterized by the step:
the fastening of the rotor-bowl on the shaft (1) before or after the fastening of the support cap (7a, 7b, 7c, 7d).

27. A procedure in accord with one of the claims 19 to 26, therein characterized, in that the open-end spin-rotor is constructed in accord with one of the claims 1 to 16.

28. An open-end spin-rotor with a shaft (1), on the free end of which a support cap (7a, 7b, 7c, 7d) can be attached, whereby the said support cap (7a, 7b, 7c, 7d) possesses a support surface (11a, 11b) for the axial bearing of the spin-rotor, therein characterized, in that in the shaft(1) and/or in the support cap (7a, 7b, 7c, 7d) at least one air escape channel is constructed.
